(19) United States
(12) Patent Application Publication
(10) Pub. No.: US 2026/0321759 A1
(43) Pub. Date: Oct. 15, 2026

(54) BATTERY PACK OVERCURRENT PROTECTION

(71) Applicant: A123 Systems LLC, Novi, MI (US)

(72) Inventors: Aman Jain, Farmington Hills, MI (US); Anudeep Peteti, Farmington Hills, MI (US); Miguel Jose Tovar, Novi, MI (US)

(21) Appl. No.: 19/644,990

(22) Filed: Apr. 10, 2026

Related U.S. Application Data
(60) Provisional application No. 63/787,629, filed on Apr. 11, 2025.

(51) Int. Cl. H01M 10/48; H01M 10/42; H01M 50/581; H01M 50/583; H02H 7/18

(52) U.S. Cl. CPC H01M 10/486; H01M 10/425; H01M 10/482; H01M 50/581; H01M 50/583; H02H 7/18; H01M 2200/103

(57) ABSTRACT

Systems and methods are provided for a battery pack include a plurality of battery cells coupled to a positive and negative terminal of the battery pack, a relay positioned between the plurality of battery cells and he positive terminal with respect to the flow of current, temperature sensitive battery components, and a controller. The controller includes instructions to lookup a maximum rated power for the temperature sensitive battery components based on a measured battery pack current, calculate a recovery time, determine protection scores based on the recovery time, and adjust the relay between an open and closed position based on the protection scores.

### CROSS-REFERENCE TO RELATED APPLICATIONS

The present application claims priority to U.S. Provisional Application No. 63/787,629 entitled “BATTERY PACK OVERCURRENT PROTECTION” and filed Apr. 11, 2025. The entire contents of the above listed application is hereby included by reference for all purposes.

### FIELD

The present description relates generally to a system and methods for protecting battery pack components from overcurrent.

### BACKGROUND AND SUMMARY

A battery system may experience an overcurrent event, which if left unmanaged may generate excessive heat and cause premature degradation of battery components, such as but not limited to, relays, fuses, and shunt resistors. Conventionally, overcurrent protection uses threshold-based triggers. For example, mechanisms such as circuit breakers, fuses, or relays may be configured to open to interrupt current flow when a certain current threshold is passed. However, thermal behavior of each individual component is not accounted for and may lead to either premature activation of the overcurrent protection or an overly delayed response. In some examples, a time-delay may be used in an overcurrent protection system to limit interruptions, but the time delay is static and may not adapt to thermal behavior of different battery components. In further examples, a circuit breaker may include I²t protection algorithms to monitor thermal impact of current over time. However, such algorithms may be in an open-loop configuration and still use pre-calculated thresholds that do not adjust for real-time changes in component temperature or dissipation rates. Further, conventional systems may demand a manual reset or use a fixed-time reset after the overcurrent event instead of a dynamic system. Such systems may result in more downtime of a system than demanded while waiting for a manual reset or a predetermined cooling time.

The inventors herein have identified the above problems and have determined solutions to at least partially overcome the above problems. In one example, a battery pack, comprises a plurality of battery cells electrically coupled to a positive terminal and negative terminal of the battery pack; a relay positioned between the plurality of battery cells and the positive terminal with respect to flow of current; temperature sensitive battery components positioned between the plurality of battery cells and the positive terminal or negative terminal with respect to the flow of current; and a controller communicatively coupled to the relay and including instructions stored in non-volatile memory that when executed cause the controller to: lookup a maximum rated power for the temperature sensitive battery components based on a measured battery pack current; calculate a recovery time for each of the temperature sensitive battery components based on the maximum rated power; determine protection scores for the relay and each of the temperature sensitive battery components based on the maximum rated power, the measured battery pack current, and the recovery time; adjust the relay between an open and closed position based on the protection scores. In this way, the system may adjust the relay based on a protection score which considers both the heat accumulated and heat dissipated by the temperature sensitive components. The system may further use the protection score to actively determine when the relay may be adjusted closed again without causing premature degradation of the temperature sensitive components.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows a block diagram of a system including a battery pack including overcurrent protection coupled to a load.

FIG. 1B shows an example of a circuit diagram of the battery pack for implementing the overcurrent protection method.

FIG. 2 shows a flowchart of an overview of an example of a method for overcurrent protection by determining protection scores.

FIG. 3 shows a flowchart of an example of a method of the overcurrent protection system for operating a battery system in response to a determined protection score.

FIG. 4 shows an example operating sequence for the overcurrent protection system.

### DETAILED DESCRIPTION

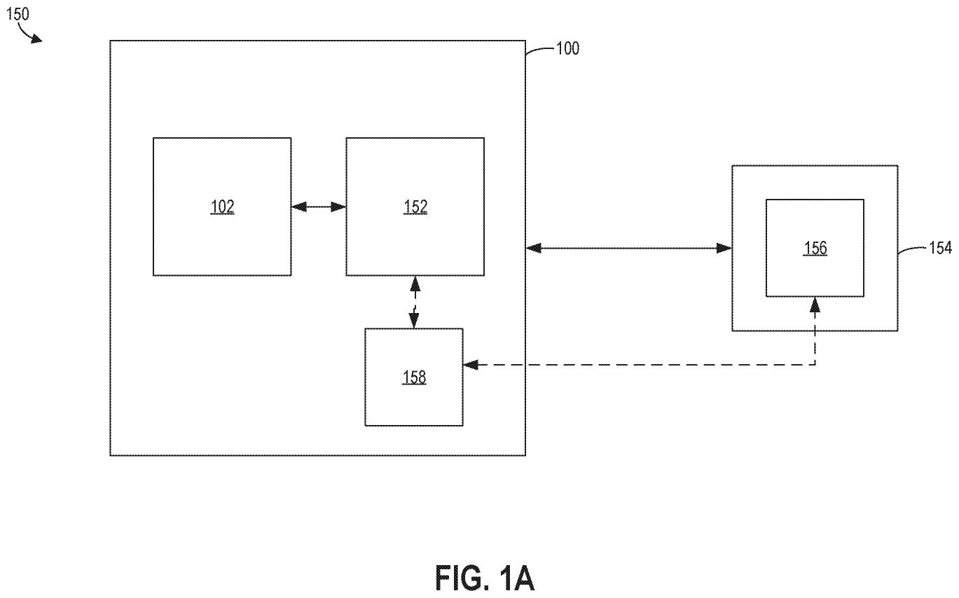

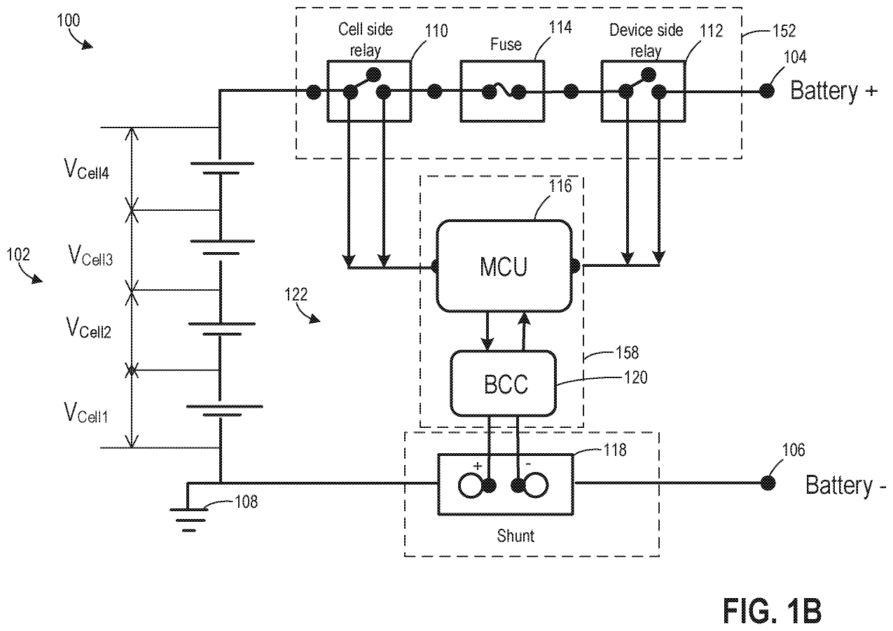

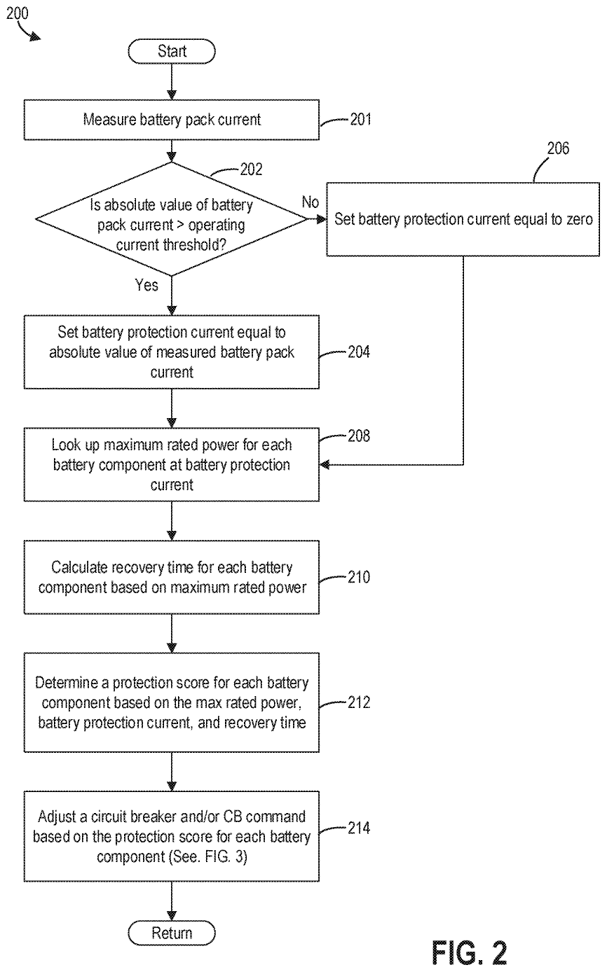

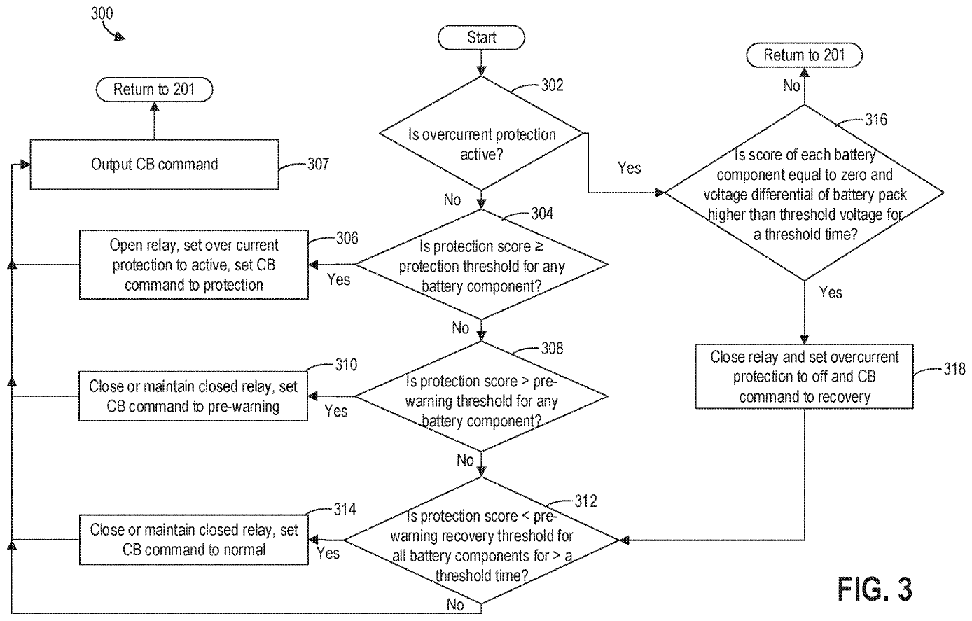

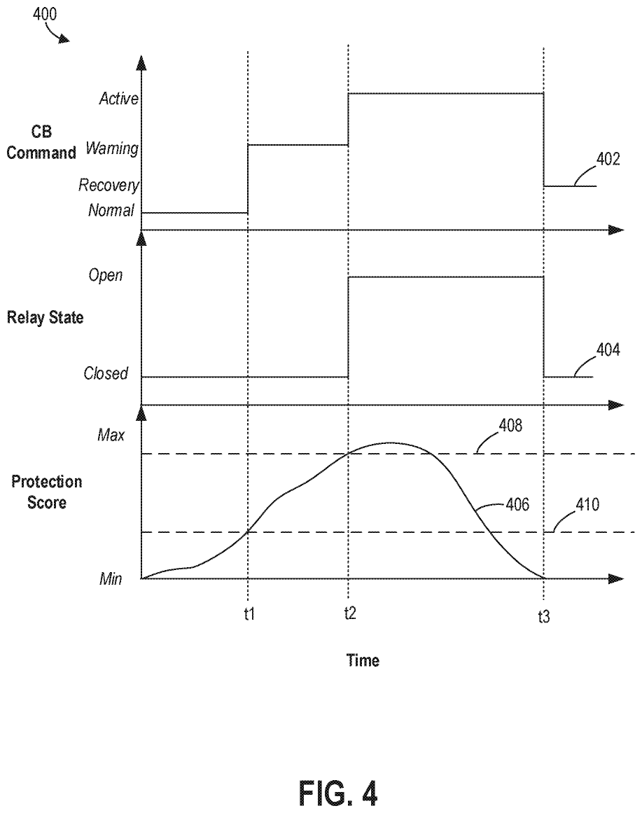

The following description relates to systems and methods for overcurrent protection of a battery pack. A block diagram of a system including a battery pack coupled to a load is shown in FIG. 1A. The battery pack may include a circuit breaker configured to interrupt current flow from the battery pack. A non-limiting example of the battery pack including the overcurrent protection is shown in a circuit diagram in FIG. 1B. The battery pack may include temperature sensitive battery components such as relays, fuses, and shunts. The battery pack may further include a controller storing instructions for overcurrent protection, such as the instructions shown in the methods of FIGS. 2-3. The battery pack may further operate as shown in the diagram of FIG. 4.

Turning now to FIG. 1A, a block diagram of a system 150 including a battery pack 100 electrically coupled to a device 154 is shown. Device 154 may be a load and/or source configured to receive energy from or supply energy to battery pack 100. In one example, when device 154 is the load, the load may be included in a vehicle. For example, the load may be an electric machine of an electric or hybrid vehicle functioning as a motor. Additionally or alternatively, the load may be a starter of an internal combustion engine and/or the load may be electrical accessories of the vehicle. As another example, the load may be residential or commercial building and the battery pack may be configured to power the electrical devices therein. In an alternate example, when device 154 is the source, the source may be included in a charging system configured to flow current to battery pack 100. For example, the source may be charging station for an electric vehicle and/or the source may be the electric machine of the vehicle functioning as a generator.

The battery pack 100 may include a plurality of battery cells 102 electrically coupled to a circuit breaker 152. The circuit breaker 152 may be configured to interrupt current flow into and out of battery pack 100. The battery pack 100 may further include a battery pack controller 158. The battery pack controller 158 may be communicatively coupled to the circuit breaker 152. The battery pack controller 158 may store instructions on non-volatile memory to protect temperature sensitive components of the battery pack, including components of circuit breaker 152 from overcurrent events. The battery pack controller 158 may be communicatively coupled to a device controller 156.

Turning now to FIG. 1B, a non-limiting example of a simplified circuit diagram of battery pack 100 is shown. As one example, battery pack 100 may include 4 battery cells connected in series. However, other battery cell configuration including different numbers of battery cells coupled in series and/or parallel are also considered within the scope of the disclosure. Battery pack 100 may include three terminals, including a positive terminal 104, a negative terminal 106, and a ground 108. Positive terminal 104 and negative terminal 106 may serve as coupling points to device 154 as described above with respect to FIG. 1A.

Circuit breaker 152 may include a relay. In one example, circuit breaker 152 may include more than one relay. For example, the more than one relay may include a cell side relay 110 and may additionally or alternatively include a device side relay 112. Both cell side relay 110 and device side relay 112 may be electrically coupled to the plurality of battery cells 102 and positioned with respect to current flow between the plurality of battery cells 102 and the positive terminal 104. Battery pack 100 may further include a fuse 114 of circuit breaker 152 positioned with respect to current flow between cell side relay 110 and device side relay 112. In some examples, circuit breaker 152 may additionally or alternatively include one or more metal oxide semiconductor field effect transistors (MOSFETs).

Cell side relay 110 and device side relay 112 may each be communicatively coupled to a controller 116. Controller 116 may be included in the battery pack controller 158. In one example, controller 116 may be a microcontroller. Controller 116 may be communicatively coupled to each of cell side relay 110 and device side relay 112 and may include instructions to open and close cell side relay 110 and device side relay 112 to protect components of battery pack 100. Controller 116 may include non-volatile memory configured to store instructions to dynamically open and close circuit breaker 152. For example, the instructions may be to open and close cell side relay 110 and/or device side relay 112 based on protection scores which take into account both accumulated heat and dissipated heat of the battery components as described further below with respect to FIGS. 2-3. In some examples, device side relay 112 may be included for redundancy to cell side relay 110. For example, the instructions may include to open device side relay 112 if the controller determines cell side relay 110 fails to open.

Battery pack 100 may further include a shunt 118 electrically coupled to the plurality of battery cells 102. Shunt 118 may be positioned with respect to current flow between the plurality of battery cells 102 and the negative terminal 106. Shunt 118 may be a low current resistor configured to measure a current flow through battery pack 100. Shunt 118 may be communicatively coupled to a battery cell controller 120. Battery cell controller 120 may be communicatively coupled to controller 116 and may also be included in battery pack controller 158. Battery cell controller 120 may include instructions stored in non-volatile memory to send a measured battery current received from shunt 118 to the controller 116. In some examples, battery cell controller 120 may be a cell monitoring unit. In an alternate example, controller 116 and battery cell controller 120 may be combined in a single controller unit.

Shunts, relays, fuses, and the like, such as those described above with respect to FIG. 1B may be included in thermally sensitive battery components 122 and each may be degraded by an overcurrent event causing a temperature increase of the battery pack. A temperature sensitivity of each of the relays, fuse, and shunt or other temperature sensitive battery components may be different and each component may also be able to dissipate heat at different rates. A conventional static overcurrent protection may underestimate thermal sensitivity of some components and overestimate others. Further, a conventional static or manual method of resetting after the overcurrent protection is activated may also be static and may not account for the different abilities of the battery components (e.g., relay, shunt, fuse) to dissipate heat during and after the overcurrent event. The method described below with respect to FIGS. 2-3 accounts for different thermal behavior of each battery component in both determining when to activate overcurrent protection and when to disable the overcurrent protection. Further, the method accounts for shoulder time periods in which an overcurrent event may occur, but preventative action may still be taken to prevent it.

Turning now to FIG. 2, an example of a method 200 for determining protection scores for a battery pack is shown. The battery pack may be battery pack 100 of FIGS. 1A-1B, for example, and may include relays, a fuse, and a shunt in addition to other temperature sensitive components. Method 200 and additional methods described herein may be stored in non-volatile memory of a controller (e.g., battery pack controller 158 of FIGS. 1A-1B) of the battery pack. Method 200 and additional methods described herein may be executed continuously when current is flowing through the battery pack. Additionally, method 200 and additional methods described herein may be executed automatically when current is flowing through the battery pack without any demanded input from a user.

At 201, method 200 measures a current of the battery pack. In an example, the battery pack current may be measured by a shunt of the battery pack, such as shunt 118 of FIG. 1B and communicated to the controller. The measured current of the battery pack may correspond to the current flowing through the circuit breaker and other temperature sensitive components of the battery pack.

At 202, method 200 determines if an absolute value of battery pack current is greater than an operating current threshold. The absolute value of battery pack current may be used to account for overcurrent protection during both charging and discharging of the battery pack. The operating current threshold may be a non-zero value that accounts for any noise or background current that may be detected in the battery pack when the battery pack is not charging or discharging. In this way, method 200 determines if the battery pack is actively being operated with a device.

If at 202, method 200 determines that the absolute value of the battery pack current is greater than the operating current threshold (YES), method 200 proceeds to 204 and includes setting a battery protection current equal to the absolute value of the battery pack current determined at 202. If at 202, method 200 determines that the absolute value of the battery pack current is less than the operating current threshold (NO), method 200 proceeds to 206 and includes setting the battery protection current equal to zero.

After the battery protection current is set at either step 204 or 206, method 200 proceeds to 208 and includes looking up a maximum rated power for each battery component at the set battery protection current. Lookup tables may be stored in non-volatile memory of the controller (e.g., battery pack controller 158 of FIGS. 1A-1B) including max rated power as a function of current for each battery component. Each battery component may include each temperature sensitive battery component of the battery pack. For example, each battery component may include relays, fuses, and shunts of the battery pack. For example, each battery component may include the cell side relay 110, device side relay 112, fuse 114, and shunt 118 of battery pack 100 of FIG. 1B. In alternate examples, method 200 may include looking up one of or a subset of each temperature sensitive battery component. The relationship between the current and the maximum rated power may depend on the ability of the battery component to withstand the increased temperatures due to increased current passing through the component. A component able to withstand higher temperatures may have a higher maximum rated power for a given current. In this way, maximum rated power may be used as a measure of thermal robustness of a battery component.

At 210, method 200 includes calculating a recovery time for each battery component based on the maximum rated power retrieved at step 208. The recovery time may further depend on a rated power percent and a recovery time percent for each battery component respectively. The rated power percent and rated recovery time percent may be set based on a desired margin around the absolute recovery time threshold. For example, the rated power percent may be increased to increase a recovery time margin, and the percent recovery time may be increased to increase a recovery time margin. The rated power percent and recovery time percent may, in one example, be determined from a specification provided by a manufacturer of the battery component. In alternate examples, the rated power percent and recovery time percent may be determined by experimental methods and/or through computer modelling of current flow through the battery component. Recovery time may be determined by equation 1 below.

$$Recovery Time ( m ) = \frac{{MaxRatedPower}_{m} * \% {RatedPower}_{m}}{{BatteryPackCurrent}^{2}} * \% {RecoveryTime}_{m} \qquad ( 1 )$$

Recovery time for the m^{th} battery component may be calculated using equation 1, where m may be a fuse, shunt, relay, or other temperature sensitive battery component. MaxRatedPowerm is the maximum rated power for the battery component determined by the look up table at step 208, BatteryPackCurrent is the current flowing through the battery pack measured at step 202, % RatedPowerm and % RecoveryTimem are determined for the m^{th} battery component empirically, experimentally, and/or computationally as described above.

At 212, method 200 includes determining a protection score for each battery component based on the max rated power, protection battery current, and recovery time. The protection score may be a value between 0 and 1 which is compared to thresholds for overcurrent protection. The protection score for the m^{th} battery component may be determined from equation 2 below.

$$Protection Score ( m ) = Min [ \text{} Max [ \text{} ( \text{} {Xn}_{m} - 1 + \frac{{BatteryProtectionCurrent}^{2} * Δ T}{{MaxRatedPower}_{m}} - \frac{Δ T}{{RecoveryTime}_{m}} ) , 0 ] , 1 ] \qquad ( 2 )$$

BatteryProtectionCurrent is the battery protection current set at step 204. ΔT is a time interval. ΔT may be equivalent to a sample rate of the controller. The sample rate may be the rate at which the controller measures a new current at 201. As one example, ΔT may be 20 milliseconds although, sample rates may vary depending on the controller and other ΔTs are also considered. The product of battery protection current squared and ΔT gives the effective power experienced by the battery component during the time interval. MaxRatedPowerm is the maximum rated power for the battery component retrieved from the lookup table at step 208. RecoveryTimem is the recovery time calculated for the battery component at step 210. Xnₘ is the protection score determined for the battery component in a previous loop of the method. In this way a first protection score may be used to determine a second protection score upon a following execution of the method, the second protection score replacing the first protection score on a second iteration of the closed loop algorithm of methods 200 and 300. As shown in equation 2, if a ratio of the effective power to the maximum rated power is greater than the ratio of ΔT to the recovery time, than the protection score is increased from the previous value and if it is less than the ratio of ΔT to the recovery time, then the protection score is decreased from the previous value.

The Min and Max function of the score may either increase the score to a minimum protection or decrease to score to be a maximum protection score. In an alternate example, equation 2 may include other scaling constants and other maximum and minimum values besides zero and one respectively may also be considered within the scope of the disclosure. In this way, a scale of the protection score is constrained to between the minimum and maximum values and may be consistent for comparison with the thresholds described further below. As one example, shown in equation 2, the minimum protection score may be zero and the maximum protection score may be one. In this way, the protection score is dynamically adjusted based on the measured current and properties of each thermally sensitive battery component.

At 214, method 200 includes adjusting a circuit breaker and/or a circuit breaker command based on the protection scores for each battery component. In one example, adjusting the circuit breaker may include adjusting a relay of the circuit breaker to be opened or closed. In some examples, adjusting the circuit breaker command may result in the controller sending a command to adjust the circuit breaker (e.g., relay). Adjusting the relay may include adjusting a relay of the battery pack, such as cell side relay 110 and/or device side relay 112 of FIG. 1B to an opened or closed state based the protection scores. Adjusting the relay may apply to both charging and discharging conditions of the battery. For this reason, the absolute value of current is used for calculating the protection score. Adjusting the circuit breaker command may include adjusting a state of the circuit breaker stored on the controller of the battery pack. The state of the circuit breaker may be output to a controller of a device electrically coupled to the battery pack (e.g., device 154 of FIG. 1A). Further details as to how the relay and circuit breaker command are adjusted in response to the determined protection score are described further below with respect to FIG. 3. Method 200 returns.

Methods 200 and 300 described herein may each comprise a closed loop algorithm. In this way, when method 200 returns, determining the protection score for each battery component may depend on the protection score calculated in the previous iteration of method 200, as described above with respect to step 212 and the protection scores may be further dynamically adjusted at each loop of methods 200.

Turning now to FIG. 3, a flowchart of a method 300 is shown. Method 300 includes steps of adjusting components of the battery pack depending on the protection score calculated in method 200. For example, method 300 describes adjusting a relay of the battery pack in response to the calculated protection score. It is understood that adjusting the relay is given as an example of adjusting a circuit breaker and the relay may be replaced with other battery components which act as circuit breakers to reversibly interrupt current flow into or out of the battery pack.

At 302, method 300 includes determining if the overcurrent protection is currently active. As one example, if overcurrent protection is currently active, the relay may be in an open state. When the relay is in the open state, current may be prevented from flowing across the relay and to the remaining battery components (e.g., the fuse and shunt). The controller (e.g., battery pack controller 158) of the battery pack may store a log which may be referred to by the method to determine if the overcurrent protection is currently active.

If at 302, method 300 determines that the overcurrent protection is not currently active, method 300 proceeds to 304 and includes determining if the protection score for any battery component is greater than or equal to a protection threshold for the respective battery component. The protection threshold may be a calibratable threshold. The protection threshold may be different for each battery component and may depend on a desired margin of protection for that component. For example, a very temperature sensitive battery component or a battery component that is hard to replace may have a lower protection threshold than a battery component that is robust and/or easy to replace. As part of step 302, method 300 may compare each protection score determined at step 212 in method 200 to its respective protection threshold. As one example, the protection thresholds may be in a range of 0.7-1.

If at 304 method 300 determines that one of the protection scores of the battery components is greater than or equal to its respective protection threshold (YES), method 300 proceeds to 306 and includes opening the relay (e.g., cell side 110 or device side relay 112), setting overcurrent protection to active, and setting circuit breaker command to protection. Opening the relay or otherwise opening the circuit breaker may prevent the overcurrent from reaching the temperature sensitive battery component. Method 300 then proceeds to 307.

At 307, method 300 includes outputting the circuit breaker command. For example, the circuit breaker command may be output to a controller of the device coupled to the battery pack (e.g., a master controller). In some examples, a status of the circuit breaker command may be sent (e.g., via a CAN bus) by the battery pack controller to a controller of the device powered by the battery pack. In some examples, the circuit breaker command may be read by the controller of the device and a message that the battery pack is under overcurrent protection may be displayed by the controller of the device and may determine that the relay is open and that the battery controller is in protection mode. Additionally, or alternatively, operation of the device may be adjusted to help mitigate the overcurrent in response to the output of the circuit breaker command. Method 300 then returns to 201 of method 200 and the closed loop algorithm continues to monitor the currents and calculating new protection scores for the battery components.

If at 304, method 300 determines none of the protection scores of the battery components are greater than or equal to its respective protection threshold (NO), method 300 proceeds to 308 and determines if the protection score for any battery component is greater than a pre-warning threshold. A pre-warning threshold may be set to a different value for each battery component. The pre-warning threshold may be set to a protection score which indicates an overcurrent could be about to happen but has not happened yet. The pre-warning threshold for each battery component may be lower than the protection threshold for the same component. In one example, pre-warning thresholds may be in a range of 0.6 to 0.9, although other ranges have also been considered.

If at 308, method 300 determines that any of the protection scores are greater than its respective pre-warning threshold (YES), method 300 proceeds to 310. At 310, method 300 includes closing the relay, if it was open, or maintaining the relay in the closed position, if the relay was closed, and setting the circuit breaker command to pre-warning. In some examples, 310 may not include maintaining the relay closed and not closing the relay because the method may not reach step 310 if the relay was opened for overcurrent protection. When the relay is in the closed position, current may flow through the battery pack and reach each of the battery components. Method 300 then proceeds to 307 and includes outputting the circuit breaker command. Outputting the pre-warning circuit breaker command may, in some examples, be read by a controller of the device coupled to the battery pack and a warning may be displayed to a user of the device. Additionally or alternatively, the controller of the device may adjust operation of the device to help prevent the overcurrent event. Method 300 then proceeds to return to step 201 of method 200.

If at 308, method 300 determines that none of the protection scores are greater than their respective pre-warning thresholds (NO), method 300 proceeds to 312 and determines if all of the protection scores are less than a respective pre-warning recovery threshold for a duration. The duration may be a time period for which the protection score remains less than the pre-warning recovery threshold is enough to proceed to normal operation. The pre-warning recovery threshold may be less than the pre-warning threshold hold. The pre-warning recovery threshold may be a number for the protection score that indicates that the battery component is not in danger of damage due to overcurrent. The pre-warning recovery threshold may be in a range of 0 to 0.6, although other ranges are also considered.

If at 312, method 300 determines that the protection score for all battery components is less than their respective pre-warning recovery thresholds (YES), method 300 proceeds to 314 and includes closing the relay or maintaining the relay in a closed position if it was not previously open and setting the circuit breaker command to normal. Closing or maintaining closed the relay may maintain a flow of current to the components of the battery pack and normal operation of the battery pack may continue. Method 300 proceeds to 307.

At 307, method 300 includes outputting the circuit breaker command. Outputting the circuit breaker command to normal may also, as discussed above, send a signal to a different controller that the battery pack is operating as normal. Method 300 may then proceed to return to step 201 of method 200. If at 312, method 300 determines that the protection score for all battery components is not less than their respective pre-warning recovery thresholds for a threshold time (NO), method 300 also proceeds to return to step 201 of method 200.

Returning now to 302, if method 300 determines that overcurrent protection is currently active (YES), method 300 proceeds to 316 determines if the protection score of each battery component is equal to zero and a voltage differential of the battery pack is higher than a threshold voltage for a threshold time. The voltage differential may be defined as a difference between a voltage measured at the battery pack cells and voltage measured at the battery pack terminals. A voltage differential below the threshold voltage may correspond to the battery pack coupled to a charger. In an overcurrent event, a charge of the battery may be significantly drained. Return to normal operation if the voltage differential is below the threshold voltage may lead to premature degradation of the battery pack and its components. The threshold time may be a time above which the voltage differential may be a real voltage difference and not due to a short pulse of voltage. As one example, the threshold time may be greater than or equal to 500 ms. Other threshold times are also considered within the scope of the disclosure.

If the method 300 determines that the conditions of 316 are not met (NO), method 300 returns to step 201 of method 200. If method 300 determines that the conditions of 316 are met (YES), method 300 proceeds to 318 and includes closing the relay, setting the overcurrent protection to OFF and the circuit breaker command to recovery. Setting the overcurrent protection to OFF may log in the BMS that the relay is currently in a closed state. Setting the circuit breaker command to recovery may create a log in the BMS that an overcurrent protection event has occurred and is over. As discussed above the BMS may communicate information about the command to the separate controller. Method 300 then returns to 312 and evaluates the protection scores against the pre-warning recovery thresholds.

FIG. 4 shows an operating sequence 400 of a battery pack, such as battery pack 100 of FIGS. 1A-1B is shown. The operating sequence 400 may be provided by battery pack 100 in cooperation with methods 200 and 300 as described above with respect to FIGS. 2-3. The vertical lines t1-t3 represent times of interest during the operating sequence. The plots are time aligned.

The first plot from the top of FIG. 4 is related to the circuit breaker command. The vertical axis represents the command (active, warning, recovery, or normal). The horizontal axis represents time and increases from the left side to the right side of the plot. Trace 402 corresponds the circuit breaker command.

The middle plot of FIG. 4 is related to the relay state. The vertical axis represents the state, either open or closed. The relay may be the relay 110 and/or the relay 112 of FIG. 1B. The horizontal axis represents time and increases from the left side to the right side of the plot. Trace 404 corresponds to the relay state.

The bottom plot of FIG. 4 is related to the protection score of one of the thermally sensitive battery components. The vertical axis represents the protection score which increases from a minimum value to a maximum value, going up the vertical axis. The horizontal axis represents time and increases from the left side to the right side of the plot. Trace 406 corresponds to the correction score of the thermally sensitive battery component. Line 410 corresponds to the pre-warning threshold and line 408 corresponds to the protection threshold.

At the start of the operating sequence, the protection score of the battery component is zero, the CB command is normal, and the relay is closed, allowing current to flow through the components of the battery pack and to a device coupled to the battery pack. As the battery pack operates, the protection score of the battery component may start to increase.

At time t1, the protection score goes above the pre-warning threshold 410. As a result, the CB command switched from normal to warning. The relay remains closed and current continue to flow through the battery pack. After switching the CB command to warning, operation of the device and/or battery pack may change to attempt to decrease the protection score. For example, the battery pack may an amount of currently flowing through the battery pack or may activate a cooling system of the battery pack. In the example operating sequence, between t1 and t2, the rate of increase of the protection score is decreased but the protection score continues to increase.

At time t2, the protection score goes above the protection threshold 408. As a result, the CB command is switch to active and the relay is opened. Opening the relay stops flow of current through the battery pack. After opening the relay, the battery component may start to dissipate thermal energy, and as a result the protection score starts to decrease between t2 and t3. While the heat is dissipating, the CB command stays active and the relay remains open.

At time t3, the protection score reaches the minimum value. As a result, the CB command is switched to recovery and the relay state is again closed. In this way, the relay is triggered to open by a protection score going above the threshold, which stops the flow of current and protects the battery component from the overcurrent event. Further, the relay is not closed again until the heat is actively determined to be dissipated as evidenced by a minimum protection score.

The technical effect of methods 200 and 300 are to open and close a circuit breaker (e.g., relay) of the battery pack in response to dynamic measurement and evaluation of both heat generated by the current within each battery component and heat dissipated by each battery component. In this way, the relay may be opened when any of the battery components is demanding overcurrent protection and may be closed when each battery component is recovered. Dynamically evaluating each battery component based on heat stored and heat dissipated allows for opening at times demanded for protection of the battery components that is neither too early nor too late followed by automatically closing the relay to maximize operational time of the battery pack without further degradation of the battery components due to lingering heat of the overcurrent. The overcurrent protection system and method may increase the battery pack lifetime by preventing excessive current from flowing through battery components while also balancing performance of battery pack.

The disclosure also provides support for a battery pack, comprising: a plurality of battery cells electrically coupled to a positive terminal and negative terminal of the battery pack, a relay positioned between the plurality of battery cells and the positive terminal with respect to flow of current, temperature sensitive battery components positioned between the plurality of battery cells and the positive terminal or negative terminal with respect to the flow of current, and a controller communicatively coupled to the relay and including instructions stored in non-volatile memory that when executed cause the controller to: lookup a maximum rated power for the temperature sensitive battery components based on a measured battery pack current, calculate a recovery time for each of the temperature sensitive battery components based on the maximum rated power, determine protection scores for the relay and each of the temperature sensitive battery components based on the maximum rated power, the measured battery pack current, and the recovery time, adjust first relay between an open and closed position based on the protection scores. In a first example of the system, the temperature sensitive battery components include a shunt, and the shunt is configured to measure the measured battery pack current. In a second example of the system, optionally including the first example, the protection scores are based on a ratio of effective power to maximum rated power and on ratio of a time interval to the recovery time. In a third example of the system, optionally including one or both of the first and second examples, the instructions comprise a closed loop algorithm and a first protection score is used to determine a second protection score on a following execution of the instructions. In a fourth example of the system, optionally including one or more or each of the first through third examples, absolute value of the measured battery pack current is used to determine the recovery time and protection score when the measured battery pack current is above an operating threshold. In a fifth example of the system, optionally including one or more or each of the first through fourth examples, a lookup table including maximum rated power for each temperature sensitive battery component as a function of battery pack current is stored in the non-volatile memory of the controller. In a sixth example of the system, optionally including one or more or each of the first through fifth examples, the instructions further include to set a circuit breaker command based on the protection scores.

The disclosure also provides support for a method for protecting a battery pack during an overcurrent event, comprising: measuring a battery pack current, the battery pack including a plurality of battery cells, a relay, and temperature sensitive battery components, looking up a maximum rated power for each of the relay and the temperature sensitive battery components based on the measured battery pack current, calculating a recovery time for each of the relay and the temperature sensitive battery components based on the maximum rated power, determining protection scores for the relay and the temperature sensitive battery components based on the maximum rated power, the measured battery pack current, and the recovery time, and opening or closing the relay based on the protection scores. In a first example of the method, the temperature sensitive battery components include a fuse and a shunt. In a second example of the method, optionally including the first example, opening or closing the relay based on the protection scores includes comparing the protection scores to a protection threshold, a pre-warning threshold, and a recovery threshold. In a third example of the method, optionally including one or both of the first and second examples, the method further comprises: opening the relay in response to a protection score of the protection scores greater than or equal to the protection threshold. In a fourth example of the method, optionally including one or more or each of the first through third examples, the method further comprises: closing the relay in response to a protection score of the protection scores greater than the pre-warning threshold and less than the protection threshold. In a fifth example of the method, optionally including one or more or each of the first through fourth examples, the method further comprises: closing the relay in response to each protection score of the protection scores less than the pre-warning threshold for greater than a threshold time.

The disclosure also provides support for a battery controller of a battery pack electrically communicatively coupled to a device, comprising: a non-volatile memory storing instructions that when executed cause the battery controller to: determine a protection score for a temperature sensitive battery component to be protected from overcurrent, compare the protection score for of the temperature sensitive battery component to a protection threshold, and in response to the protection score being greater than or equal to the protection threshold, open a relay of the battery pack. In a first example of the system, the instructions further include to measure a current of the battery pack and the protection score is based on a maximum rated power of the temperature sensitive battery component at the measured current. In a second example of the system, optionally including the first example, the instructions further include to calculate a recovery time based on the maximum rated power and the measured current. In a third example of the system, optionally including one or both of the first and second examples, the instructions further include to set a circuit breaker command stored on the battery controller to protection. In a fourth example of the system, optionally including one or more or each of the first through third examples, the instructions further include to output the circuit breaker command to the device. In a fifth example of the system, optionally including one or more or each of the first through fourth examples, the instructions further comprise to close the relay in response to the protection score equal to zero and a voltage differential of the battery pack about a threshold voltage. In a sixth example of the system, optionally including one or more or each of the first through fifth examples, the protection score is constrained to be between a minimum protection score and a maximum protection score.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack, comprising:
a plurality of battery cells electrically coupled to a positive terminal and negative terminal of the battery pack;
a relay positioned between the plurality of battery cells and the positive terminal with respect to flow of current;
temperature sensitive battery components positioned between the plurality of battery cells and the positive terminal or negative terminal with respect to the flow of current; and
a controller communicatively coupled to the relay and including instructions stored in non-volatile memory that when executed cause the controller to:
lookup a maximum rated power for the temperature sensitive battery components based on a measured battery pack current;
calculate a recovery time for each of the temperature sensitive battery components based on the maximum rated power;
determine protection scores for the relay and each of the temperature sensitive battery components based on the maximum rated power, the measured battery pack current, and the recovery time; and
adjust the relay between an open and closed position based on the protection scores.

2. The battery pack of claim 1, wherein the temperature sensitive battery components include a shunt, and the shunt is configured to measure the measured battery pack current.

3. The battery pack of claim 1, wherein the protection scores are based on a ratio of effective power to maximum rated power and on ratio of a time interval to the recovery time.

4. The battery pack of claim 1, wherein the instructions comprise a closed loop algorithm and a first protection score is used to determine a second protection score on a following execution of the instructions.

5. The battery pack of claim 1, wherein an absolute value of the measured battery pack current is used to determine the recovery time and protection score when the measured battery pack current is above an operating threshold.

6. The battery pack of claim 1, wherein a lookup table including maximum rated power for each temperature sensitive battery component as a function of battery pack current is stored in the non-volatile memory of the controller.

7. The battery pack of claim 1, wherein the instructions further include to set a circuit breaker command based on the protection scores.

8. A method for protecting a battery pack during an overcurrent event, comprising:
measuring a battery pack current, the battery pack including a plurality of battery cells, a relay, and temperature sensitive battery components;
looking up a maximum rated power for each of the relay and the temperature sensitive battery components based on the measured battery pack current;
calculating a recovery time for each of the relay and the temperature sensitive battery components based on the maximum rated power;
determining protection scores for the relay and the temperature sensitive battery components based on the maximum rated power, the measured battery pack current, and the recovery time; and
opening or closing the relay based on the protection scores.

9. The method of claim 8, wherein the temperature sensitive battery components include a fuse and a shunt.

10. The method of claim 8, wherein opening or closing the relay based on the protection scores includes comparing the protection scores to a protection threshold, a pre-warning threshold, and a recovery threshold.

11. The method of claim 10, further comprising opening the relay in response to a protection score of the protection scores greater than or equal to the protection threshold.

12. The method of claim 10, further comprising closing the relay in response to a protection score of the protection scores greater than the pre-warning threshold and less than the protection threshold.

13. The method of claim 10, further comprising closing the relay in response to each protection score of the protection scores less than the pre-warning threshold for greater than a threshold time.

14. A battery controller of a battery pack electrically communicatively coupled to a device, the battery controller comprising:
a non-volatile memory storing instructions that when executed cause the battery controller to:
determine a protection score for a temperature sensitive battery component to be protected from overcurrent;
compare the protection score for of the temperature sensitive battery component to a protection threshold; and
in response to the protection score being greater than or equal to the protection threshold, open a relay of the battery pack.

15. The battery controller of claim 14, wherein the instructions further include to measure a current of the battery pack and the protection score is based on a maximum rated power of the temperature sensitive battery component at the measured current.

16. The battery controller of claim 15, wherein the instructions further include to calculate a recovery time based on the maximum rated power and the measured current.

17. The battery controller of claim 14, wherein the instructions further include to set a circuit breaker command stored on the battery controller to protection.

18. The battery controller of claim 17, wherein the instructions further include to output the circuit breaker command to the device.

19. The battery controller of claim 17, wherein the instructions further comprise to close the relay in response to the protection score equal to zero and a voltage differential of the battery pack about a threshold voltage.

20. The battery controller of claim 14, wherein the protection score is constrained to be between a minimum protection score and a maximum protection score.
